(19) United States
(12) Patent Application Publication
(10) Pub. No.: US 2020/0287974 A1
(43) Pub. Date: Sep. 10, 2020

(54) SYSTEM AND METHOD FOR SWITCHING BETWEEN PUBLISH/SUBSCRIBE SERVICES

(71) Applicant: Cloud of Things Ltd., Tel Aviv (IL)

(72) Inventor: Eliav Gnessin, Givat Brenner (IL)

(21) Appl. No.: 16/291,044

(22) Filed: Mar. 4, 2019

(51) Int. Cl. H04L 29/08; H04L 12/26; H04L 29/06

(52) U.S. Cl. CPC H04L 67/142; H04L 43/0823; H04L 43/0882; H04L 67/26; H04L 43/087; H04L 67/10; H04L 63/0876; H04L 43/0888

(57) ABSTRACT

A method for switching between publish/subscribe services, the method comprising: monitoring performance measures of a first publish/subscribe service provided by a first secure network of interconnected computers, the first publish/subscribe service used by a plurality of connected devices connected to the first secure network of interconnected computers via respective first connections; upon one or more of the performance measures failing to meet respective performance requirements, identifying a second publish/subscribe service provided by a second secure network of interconnected computers, wherein the performance measures of the second publish/subscribe service meet the respective performance requirements; sending switch instructions for switching the connection of at least a sub-group of the connected devices from the respective first connections to the first secure network of interconnected computers to respective second connections to the second secure network of interconnected computers.

### TECHNICAL FIELD

The invention relates to a system and method for switching between publish/subscribe services.

BACKGROUND

Many devices (including, for example, home appliances, cars, electronic signs, and many more) are designed nowadays to connect to the Internet. Such devices are referred to herein as: “connected devices”. Many of the connected devices are pre-configured to automatically connect to a given pre-defined network of interconnected computers, inter alia for storing and/or analyzing various information obtained by the connected device and sent to such given network for this purpose. However, the connected devices are limited to communicate with the given pre-defined network, operated by a given vendor/service provider (e.g. Amazon, IBM, Oracle, etc.). Seamless configuration of the connected devices to connect to another network of interconnected computers is impossible. Therefore, the connected devices depend on the availability of the given pre-defined network. In addition, each network of interconnected computers to which the connected devices can connect has different characteristics, both static and dynamic. Some examples for such characteristics include a security level, a cost (that can optionally depend on the amount of data sent to the network by a connected device—the more data is sent—the higher the cost), a communication latency, a given Service Level Agreement (SLA), and more. Matching between the requirements of a given connected device or a group of connected devices and between the characteristics of each network of interconnected computers to which such connected device/s can connect is desirable, whereas locking the connected device/s to connect to a given pre-configured configured network of interconnected computers has various disadvantages.

There is thus a need in the art for a new method and system for switching between publish/subscribe services.

### GENERAL DESCRIPTION

In accordance with a first aspect of the presently disclosed subject matter, there is provided a method for switching between publish/subscribe services, the method comprising: monitoring one or more performance measures of a first publish/subscribe service provided by a first secure network of interconnected computers, the first publish/subscribe service used by a plurality of connected devices connected to the first secure network of interconnected computers via respective first connections; upon one or more of the performance measures of the first publish/subscribe service failing to meet respective performance requirements, identifying a second publish/subscribe service provided by a second secure network of interconnected computers, wherein the performance measures of the second publish/subscribe service meet the respective performance requirements; and sending one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.

In some cases, the performance measures include at least one of: bandwidth, latency, throughput, jitter or error rate.

In some cases, the switch instruction is received by the connected devices of the sub-group via the first connection.

In some cases, the monitoring, identifying and sending is performed by a cloud switch server that is not part of the first secure network of interconnected computers and of the second secure network of interconnected computers.

In some cases, the method further comprises disconnecting the first connections of the connected devices of the sub-group after the second connections are established.

In some cases, past data associated with the connected device and stored on the first secure network of interconnected computers is migrated to the second secure network of interconnected computers after the second connection is established.

In some cases, at least one of (a) the first publish/subscribe service, or (b) the second publish/subscribe service, is an Message Queuing Telemetry Transport (MQTT) based publish/subscribe service.

In accordance with a second aspect of the presently disclosed subject matter, there is provided a system for switching between publish/subscribe services, the system comprising a processing resource configured to: monitor one or more performance measures of a first publish/subscribe service provided by a first secure network of interconnected computers, the first publish/subscribe service used by a plurality of connected devices connected to the first secure network of interconnected computers via respective first connections; upon one or more of the performance measures of the first publish/subscribe service failing to meet respective performance requirements, identify a second publish/subscribe service provided by a second secure network of interconnected computers, wherein the performance measures of the second publish/subscribe service meet the respective performance requirements; and send one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.

In some cases, the performance measures include at least one of: bandwidth, latency, throughput, jitter or error rate.

In some cases, the switch instruction is received by the connected devices of the sub-group via the first connection.

In some cases, the processing resource is part of a cloud switch server that is not part of the first secure network of interconnected computers and of the second secure network of interconnected computers.

In some cases, past data associated with the connected device and stored on the first secure network of interconnected computers is migrated to the second secure network of interconnected computers after the second connection is established.

In some cases, at least one of (a) the first publish/subscribe service, or (b) the second publish/subscribe service, is an Message Queuing Telemetry Transport (MQTT) based publish/subscribe service.

In accordance with a third aspect of the presently disclosed subject matter, there is provided a non-transitory computer readable storage medium having computer readable program code embodied therewith, the computer readable program code, executable by at least one processing resource of a computer to perform a method comprising: monitoring one or more performance measures of a first publish/subscribe service provided by a first secure network of interconnected computers, the first publish-subscribe service used by a plurality of connected devices connected to the first secure network of interconnected computers via respective first connections; upon one or more of the performance measures of the first publish/subscribe service failing to meet respective performance requirements, identifying a second publish/subscribe service provided by a second secure network of interconnected computers, wherein the performance measures of the second publish/subscribe service meet the respective performance requirements; and sending one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIGS. 1 and 8 are schematic illustrations of an environment of a system for configuration of a connected device connection, in accordance with the presently disclosed subject matter;

FIG. 2 is a block diagram schematically illustrating one example of a connected device, in accordance with the presently disclosed subject matter;

FIG. 3 is a block diagram schematically illustrating one example of a cloud switch, in accordance with the presently disclosed subject matter;

FIGS. 4 and 6 are flowcharts illustrating one example of sequences of operations carried out for connecting a connected device to a network of interconnected computers, in accordance with the presently disclosed subject matter; and

FIGS. 5 and 7 are flowcharts illustrating one example of sequences of operations carried out for reconfiguring a connected device to connect to another network of interconnected computers, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “monitoring”, “identifying”, “sending”, “receiving”, “establishing”, “repeating”, “receiving”, “disconnecting”, “obtaining”, “migrating” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

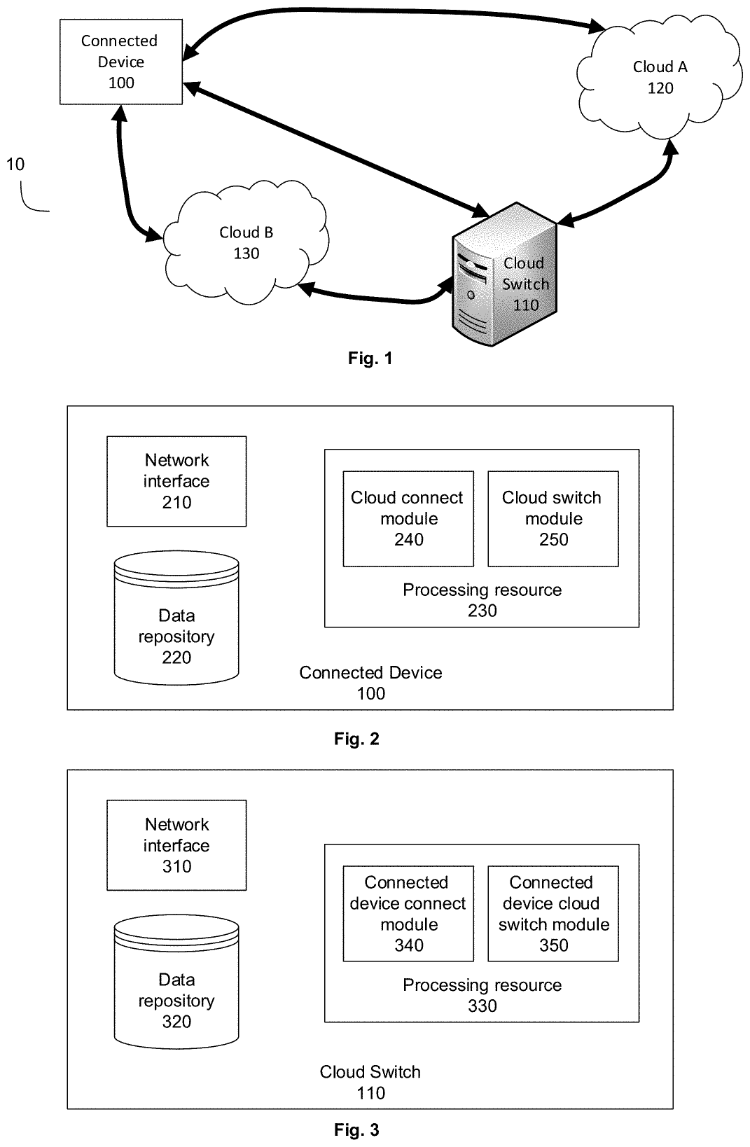

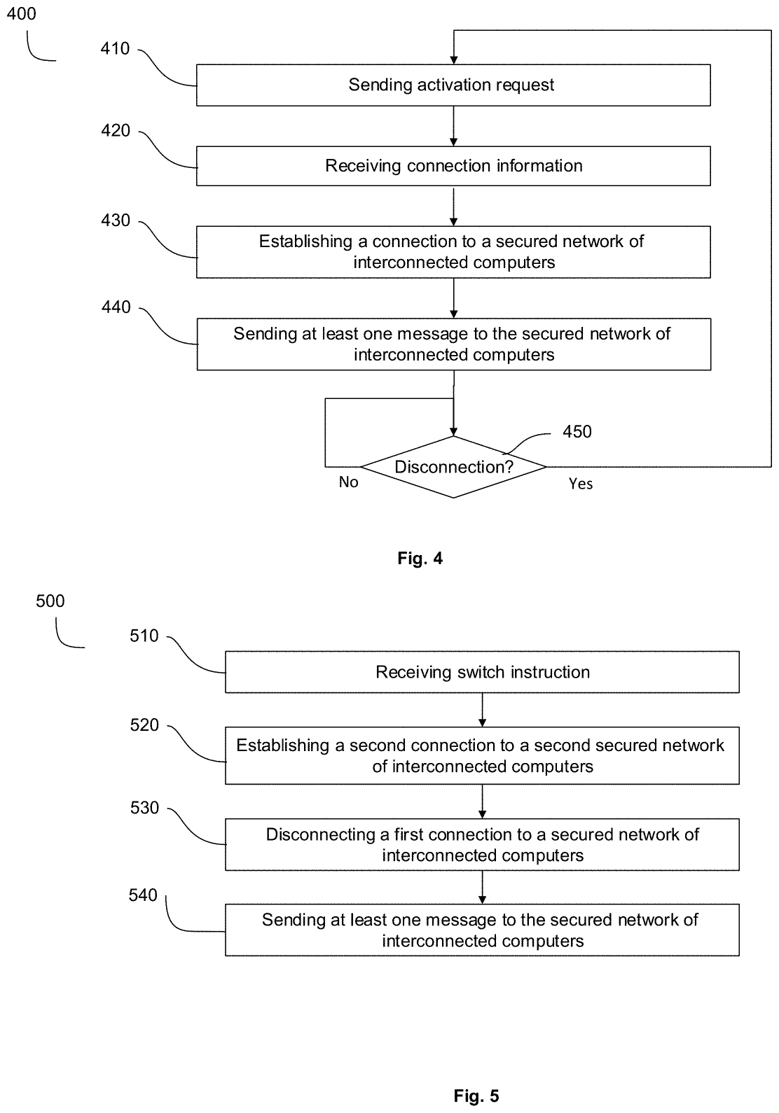

In embodiments of the presently disclosed subject matter, fewer, more and/or different stages than those shown in FIG. 4-7 may be executed. In embodiments of the presently disclosed subject matter one or more stages illustrated in FIG. 4-7 may be executed in a different order and/or one or more groups of stages may be executed simultaneously. FIGS. 1-3 and 8 illustrate a general schematic of the system architecture in accordance with an embodiment of the presently disclosed subject matter. Each module in FIGS. 1-3 and 8 can be made up of any combination of software, hardware and/or firmware that performs the functions as defined and explained herein. The modules in FIGS. 1-3 and 8 may be centralized in one location or dispersed over more than one location. In other embodiments of the presently disclosed subject matter, the system may comprise fewer, more, and/or different modules than those shown in FIGS. 1-3 and 8.

Bearing this in mind, attention is drawn to FIG. 1, a schematic illustration of an environment of a system for configuration of a connected device connection, in accordance with the presently disclosed subject matter.

According to certain examples of the presently disclosed subject matter, the environment 10 can include at least one connected device 100, at least one cloud switch 110, and at least two distinct secure networks of interconnected computers (a secure network of interconnected computers is also referred to herein as “cloud”)—cloud A 120 and cloud B 130. In some cases, a cloud can be a secure network of interconnected computers that requires authentication (e.g. using any authentication mechanism such as a device identifier and a corresponding security token (e.g. password)) of any connected device 100 attempting to connect thereto and/or to communicate therewith, where each such cloud generates (e.g. utilizing one or more computers of the secure network of interconnected computers forming such cloud) at least part of the information used for authenticating any connected device 100 authorized to connect thereto.

A connected device 100 is any device designed to connect to a communication network (e.g. any type of Internet Protocol (IP) based network such as the Internet), and through which to a given cloud, and to a given publish/subscribe service (e.g. an Message Queuing Telemetry Transport (MQTT) based publish/subscribe service) for publishing messages on one or more channels to which the connected device 100 is registered and/or for receiving messages published on the one or more channels to which the connected device 100 is registered. Some examples of connected devices include home appliances, cars, electronic signs, etc. all of which designed to connect to a communication network and to a publish/subscribe service. Each connected device 100 is designed to send various information obtained thereby to the given cloud, e.g. for storage and/or analysis.

In accordance with the prior art, a connected device 100 includes a firmware pre-configured to connect (optionally automatically) the connected device 100 on which it is installed, via the communication network, to a given pre-defined cloud, such as cloud A 120. Upon activation of such connected device 100, it connects (optionally automatically, or upon a suitable command received from the user) to the communication network (e.g. the Internet) and through such connection it connects to the given pre-defined cloud to which it is pre-configured to connect (e.g. cloud A 120). Remotely configuring such connected device 100 to connect to another cloud (e.g. cloud B 130), is impossible according to the prior art.

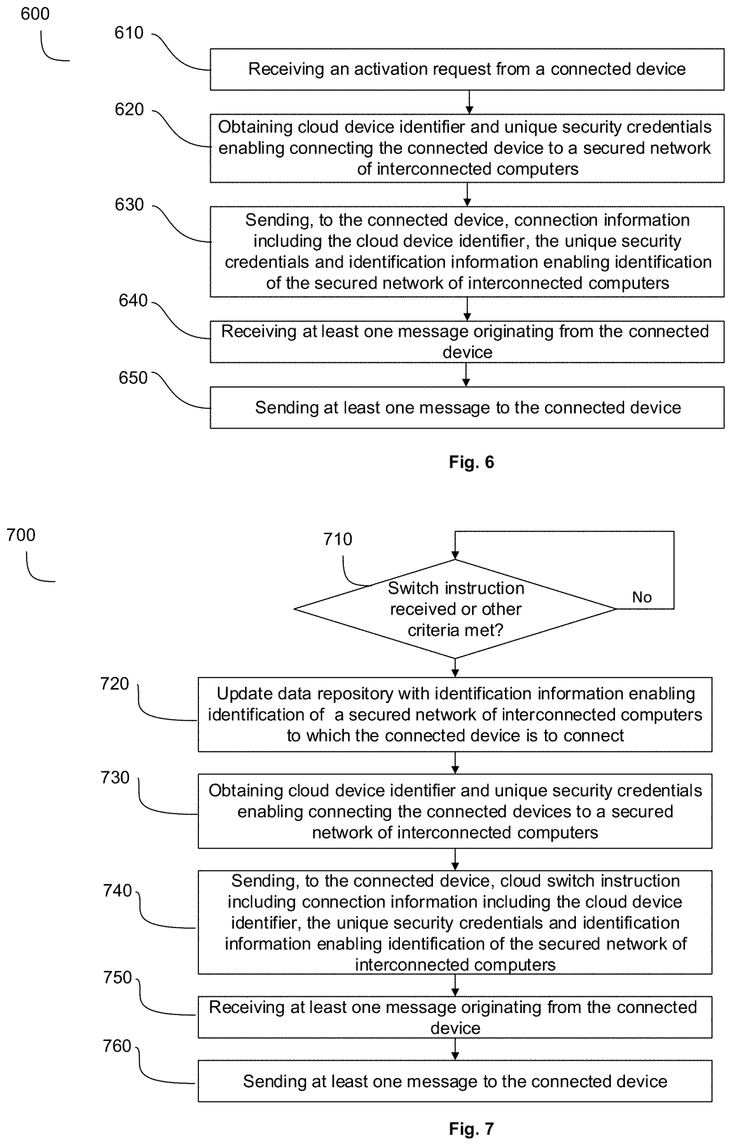

As opposed to the prior art (where each connected device 100 includes a firmware pre-configured to connect the connected device 100 on which it is installed to a given pre-defined cloud), the connected device 100 according to the presently disclosed subject matter includes a firmware pre-configured to connect (optionally automatically) the connected device 100 on which it is installed, via the communication network, to a cloud switch 110. The cloud switch 110 can be one or more physical servers and/or virtual servers capable of connecting to the communication network and capable of communicating with the connected device 100, and with one or more clouds (e.g. cloud A 120, cloud B 130, etc.) therethrough. In some cases, the cloud switch 110 can be part of one of the clouds (e.g. cloud A 120, cloud B 130, etc.). The connected device 100 and the cloud switch 110 are configured to perform a connection process, as further detailed with respect to FIGS. 4 and 6 for establishing a first connection between the connected device 100 and a first cloud (e.g. cloud A 120), and for registering to one or more channels of a publish/subscribe service (e.g. an MQTT based publish/subscribe service) provided by the first cloud (e.g. cloud A 120). In addition, upon a command to switch clouds, or upon certain criteria being met, the connected device 100 and the cloud switch 110 are configured to perform a cloud switch process for disconnecting the connected device 100 from the cloud it is connected to (e.g. cloud A 120) and connect it to another cloud, other than the cloud it is connected to (e.g. cloud B 130), and for registering it to one or more channels of a publish/subscribe service (e.g. an MQTT based publish/subscribe service) provided by other cloud (e.g. cloud B 130), as further detailed with respect to FIGS. 5 and 7. It is to be noted that in some cases, one or more connected devices 100 can be capable of being connected to more than one cloud (e.g. a given connected device 100 can be connected to cloud A 120 and to cloud B 130 simultaneously). In such cases, a given connected device 100 can be simultaneously registered to one or more channels of two (or more) publish/subscribe services, one provided by cloud A 120 and one provided by cloud B 130. In some cases, the given connected device 100 can be configured to publish any message generated thereby on the channels of both publish/subscribe services (provided by cloud A 120 and by cloud B 130), or it can have a mechanism for deciding on which publish/subscribe service to publish each message generated thereby (on the publish/subscribe service provided by cloud A 120 or on the publish/subscribe service provided by cloud B 130).

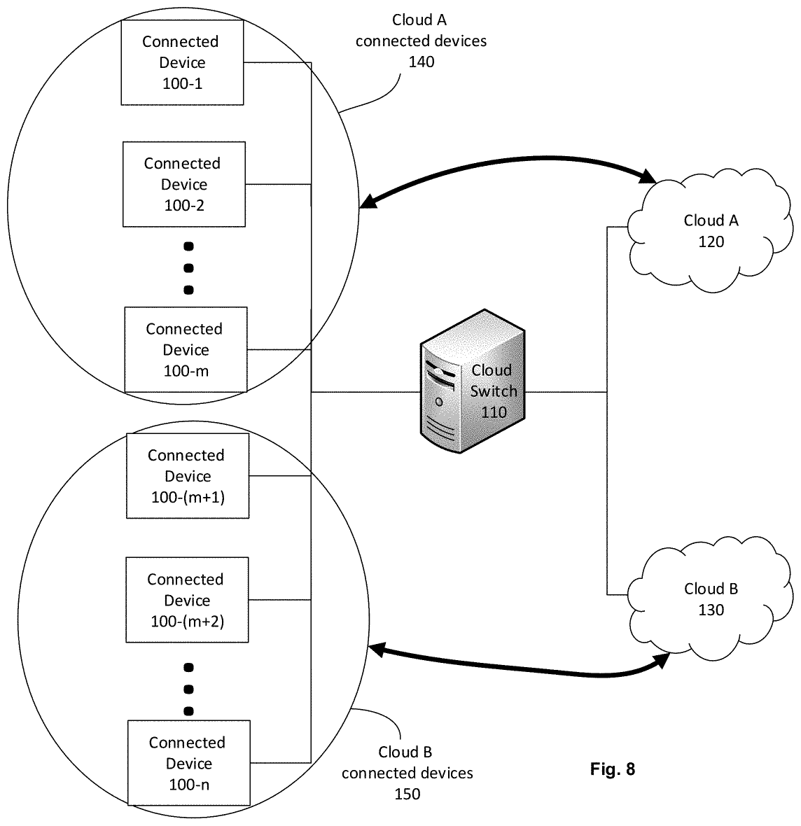

Turning to FIG. 8, it can be appreciated that the environment 10 can comprise a plurality of connected devices 100 (e.g. connected device 100-1, connected device 100-2, . . . , connected device 100-m (m being an integer larger than 2), connected device 100-(m+1), connected device 100-(m+2), connected device 100-n (n being an integer larger than m+2)). In some cases, cloud A connected devices 140 can include connected devices 100-1 to 100-m, all of which connect to cloud A, whereas cloud B connected devices 150 can include connected devices 100-m+1 to 100-n, all of which connect to cloud B 130. The connection of the connected devices 100-1 to 100-n to the respective clouds (cloud A 120 and cloud B 130) can be established in accordance with the connection process detailed herein with respect to FIGS. 4 and 6. In accordance with the presently disclosed subject matter, one or more of the cloud A connected devices 140 and/or one or more of the cloud B connected devices 150, can be configured (optionally remotely, e.g. by the cloud switch 110) to switch clouds for connecting with clouds different than the ones they are connected to, e.g. in accordance with the cloud switch process detailed herein with respect to FIGS. 5 and 7.

In some cases, the instruction to switch clouds can originate from a user (e.g. a manufacturer of a certain group of connected devices 100), e.g. in light of various considerations such as various performance measures relating to the various clouds (e.g. cloud A 120 can have better latency/availability/bandwidth/etc. compared to cloud B 130), costs associated with the connected device 100 connecting to and/or communicating with various clouds (as the cost of a connected device 100 connecting to and/or communicating with a first cloud (e.g. cloud A 120) can be different than the costs of connecting to and/or communicating with a second cloud (e.g. cloud B 130)), security-related offerings of the various clouds (e.g. cloud A 120 can meet various security requirements/standards not met by cloud B 130).

In other cases, the instruction to switch clouds can be initiated by the cloud switch 110, or by the connected device itself, e.g. upon one or more criteria being met. Such criteria can include one or more of the following non-limiting exemplary criteria:
a. one or more performance measures of a publish/subscribe service (e.g. an MQTT based publish/subscribe service) provided by the cloud to which the connected device is connected to do not meet a corresponding threshold or performance requirements;
b. one or more performance measures of the cloud to which the connected device is connected to do not meet a corresponding threshold;
c. one or more security requirements are not met by the cloud to which the connected device is connected to;
d. a cost of the connection to and/or communication with the cloud to which the connected device is connected to is higher than a cost of connection to and/or communication with another cloud;
e. a current time of day is within a predetermined range (e.g. in cases where the connected device 100 is to connect to different clouds at different times of day;
f. a current geographical location of the connected device is within a predetermined geographical area (e.g. in cases where the connected device 100 is to connect to different clouds depending on a geographical location thereof, e.g. if the connected device 100 is located in Europe, it can be configured to connect to cloud A 120, whereas if the connected device is located at Australia is can be configured to connect to cloud B 130);
g. any other criteria, including criteria based on Service Level Agreements (SLAs).

It is to be noted that in some cases, when switching clouds due to failure of a given cloud, or a publish/subscribe service thereof, to meet performance measures thresholds/requirements, the cloud to which the connected devices switch to is required to meet the performance measures thresholds/requirements. It is to be noted that accordingly, switching clouds can be made in order to perform load balancing between loads of a plurality of clouds/cloud service providers/publish/subscribe services, etc.

It is to be further noted that in some cases, instead of switching clouds, the connected devices 100 can be capable of simply connecting to an additional cloud additional to the cloud/s to which it is currently connected. As indicated herein, a given connected device 100 can be simultaneously connected to more than one cloud, and registered to one or more channels of two (or more) publish/subscribe services, one provided by cloud A 120 and one provided by cloud B 130. In some cases, the given connected device 100 can be configured to publish any message generated thereby on the channels of both publish/subscribe services (provided by cloud A 120 and by cloud B 130), or it can have a mechanism for deciding on which publish/subscribe service to publish each message generated thereby (on the publish/subscribe service provided by cloud A 120 or on the publish/subscribe service provided by cloud B 130). This multiple-connection mechanism can enable, for example, load balancing between a plurality of clouds/publish/subscribe services.

Having described the environment 10, attention is drawn to FIG. 2, showing a block diagram schematically illustrating one example of a connected device, in accordance with the presently disclosed subject matter.

According to certain examples of the presently disclosed subject matter, connected device 100 includes a network interface 210, optionally wireless, enabling connecting the connected device 100 to a communication network (e.g. any IP based network such as the Internet) and enabling it to send and receive data sent thereto through the communication network, including sending activation requests, receiving connection information, connecting to and communicating with a given cloud, etc., as further detailed herein, inter alia with reference to FIGS. 4 and 5.

The connected device 100 can further comprise or be otherwise associated with a data repository 220 (e.g. a database, a storage system, a memory including Read Only Memory—ROM, Random Access Memory—RAM, or any other type of memory, etc.) configured to store data, including, inter alia, information identifying the cloud switch 110 (e.g. its IP address), a unique activation key uniquely identifying the connected device 100, etc. In some cases, data repository 220 can be further configured to enable retrieval and/or update and/or deletion of the stored data.

The connected device 100 further comprises a processing resource 230. Processing resource 230 can be one or more processing units (e.g. central processing units), microprocessors, microcontrollers (e.g. microcontroller units (MCUs)) or any other computing devices or modules, including multiple and/or parallel processing units, which are adapted to independently or cooperatively process data for controlling relevant connected device 100 resources and for enabling operations related to connected device 100 resources.

The processing resource 230 can comprise one or more of the following modules: cloud connect module 240 and cloud switch module 250.

According to some examples of the presently disclosed subject matter, the cloud connect module 240 can be configured to perform a connection process for connecting the connected device 100 to a given cloud, as further detailed with respect to FIG. 4.

Cloud switch module 250 can be configured to perform a cloud switch process for connecting the connected device 100 to a cloud other than the given cloud, as further detailed with respect to FIG. 5.

Turning to FIG. 3, there is shown a block diagram schematically illustrating one example of a cloud switch, in accordance with the presently disclosed subject matter.

According to certain examples of the presently disclosed subject matter, cloud switch 110 includes a network interface 310, optionally wireless, enabling connecting the cloud switch 110 to a communication network (e.g. any IP based network such as the Internet) and enabling it to send and receive data sent thereto through the communication network, including receiving activation requests, sending connection information, connecting to and communicating with one or more clouds, etc., as further detailed herein, inter alia with reference to FIGS. 6 and 7.

The cloud switch 110 can further comprise or be otherwise associated with a data repository 320 (e.g. a database, a storage system, a memory including Read Only Memory-ROM, Random Access Memory-RAM, or any other type of memory, etc.) configured to store data, including, inter alia, information enabling identification of the connected devices 100, information enabling identification of a cloud to which each connected device 100 is to connect, etc. In some cases, data repository 220 can be further configured to enable retrieval and/or update and/or deletion of the stored data.

The cloud switch 110 further comprises a processing resource 330. Processing resource 330 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant cloud switch 110 resources and for enabling operations related to cloud switch 110 resources.

The processing resource 330 can comprise one or more of the following modules: connected device connect module 340 and connected device switch module 350.

According to some examples of the presently disclosed subject matter, the connected device connect module 340 can be configured to perform a connection process for connecting a connected device 100 to a given cloud, and to a given publish/subscribe service provided by the given cloud (e.g. an MQTT based publish/subscribe service), as further detailed with respect to FIG. 6.

Connected device switch module 350 can be configured to perform a cloud switch process for connecting a connected device 100 to a cloud other than a given cloud to which the connected device 100 is connected to, and to register to another publish/subscribe service (e.g. an MQTT based publish/subscribe service) provided by the such cloud, other than the publish/subscribe service to which the connected device 100 is connected to, as further detailed with respect to FIG. 7.

Attention is now drawn to FIGS. 4 and 6, showing flowcharts illustrating one example of sequences of operations carried out for connecting a connected device to a network of interconnected computers, in accordance with the presently disclosed subject matter.

According to some examples of the presently disclosed subject matter, connected device 100 and the cloud switch 110 can be configured to execute a cloud connection process 400 and a connected device connection process 600 respectively, for (a) connecting a connected device 100 to a given cloud, e.g. upon establishing a connection (optionally a wireless connection) between the connected device and a communication network, and (b) registering to one or more publish/subscribe channels of a publish/subscribe service (e.g. an MQTT based publish/subscribe service) provided by the given cloud. Connected device 100 can execute the cloud connection process 400 utilizing cloud connect module 240. Cloud switch 110 can execute the connected device connect process 600 utilizing the connected device connect module 340.

For this purpose, a given connected device 100 can send, via the communication network, an activation request to the cloud switch 110 (block 410). As indicated above, each connected device 100 can comprise first identification information that can be a unique activation key, or any other unique identifier uniquely identifying the given connected device 100, that can be stored on the connected device's 100 data repository 220. The activation request comprises the unique activation key uniquely identifying the given connected device 100. It is to be noted that the connected device 100 can comprise information that enables it to communicate with the cloud switch 110 (e.g. an IP address of the cloud switch 110, or other information enabling it to send the activation request thereto) via the communication network.

The activation request sent at block 410 is received by the cloud switch 110 (block 610). Upon receipt of an activation request, comprising the activation key uniquely identifying the given connected device 100, the cloud switch 110 obtains a cloud device identifier and unique security credentials enabling connecting the connected device 100 to a given cloud and registering the connected device 100 to one or more publish/subscribe channels of a publish/subscribe service (e.g. an MQTT based publish/subscribe service) provided by the given cloud (block 620).

In order to obtain the cloud device identifier and the unique security credentials, the cloud switch 110 can utilize the activation key for obtaining (e.g. by retrieving from data repository 320) information identifying a given cloud to which the given connected device 100 is to connect and one or more publish/subscribe channels of a publish/subscribe service (e.g. an MQTT based publish/subscribe service) provided by the given cloud. Such information can be provided for example by a manufacturer of the given connected device 100 or any entity having permission to decide to which cloud the given connected device 100 is to connect. Additionally, or alternatively, such information can be provided by the cloud switch 110 itself, e.g. as further detailed with respect to FIG. 7. Such information can be stored in the data repository 320 so that each activation key uniquely identifies a corresponding cloud to which the respective connected device 100, associated with the respective activation key, is to connect and one or more publish/subscribe channels of a publish/subscribe service (e.g. an MQTT based publish/subscribe service) provided by such cloud to which the connected device 100 is to register.

In addition to obtaining the information identifying the given cloud, the cloud switch 110 can be configured to check if the given connected device 100 associated with the activation key has a cloud device identifier previously generated by such given cloud and stored on the data repository 320. If so—the cloud switch 110 also obtains such cloud device identifier and requests the given cloud to generate and provide the unique security credentials for enabling the given connected device 100, associated with the obtained cloud device identifier, to connect to the given cloud. If no cloud device identifier exists for the given connected device 100—the cloud switch 110 requests the given cloud to generate and provide both the cloud device identifier for identifying the given connected device 100 at the given cloud, and the unique security credentials for enabling the given connected device 100 to connect to the given cloud and to register to one or more publish/subscribe channels of a publish/subscribe service (e.g. an MQTT based publish/subscribe service) provided by the given cloud.

If a new cloud device identifier is generated for the given connected device 100, the cloud switch 110 stores the new cloud device identifier in the data repository in association with the given connected device 100 and with given cloud (that generated such cloud device identifier) for future use. It is to be noted that in some cases for each connected device 100 that connects to a given cloud, the given cloud generates information that enables at least storing various information received from such connected device 100 in the given cloud. In some cases, for each connected device 100 that connects to a newly designated cloud, the newly designated cloud allocates storage space for storing data originating from such connected device 100.

Once the cloud device identifier and the unique security credentials associated with the given connected device 100 are obtained at block 620, the cloud switch 110 can send, to the given connected device 100, via the communication network, connection information enabling connecting the given connected device 100 to the given cloud, and registering the given connected device 100 to one or more publish/subscribe channels of a publish/subscribe service (e.g. an MQTT based publish/subscribe service) provided by the given cloud (block 630). The connection information includes the cloud device identifier and the unique security credentials obtained at block 620, identification information enabling identification of the given cloud to which the given connected device 100 is to connect, and information identifying the publish/subscribe channels of a publish/subscribe service (e.g. an MQTT based publish/subscribe service) provided by the given cloud to which the given connected device 100 is to register. The identification information enabling identification of the given cloud to which the given connected device 100 is to connect can include a Uniform Resource Locator (URL) associated with the given cloud (or more specifically with a specific endpoint, such as a computer, a router, a load balancer, etc., that is part of the given cloud) through which the given connected device 100 can connect to the given cloud using the cloud device identifier and the unique security credentials provided thereto. It is to be noted that a URL using Fully Qualified Domain Name (FQDN) is one example of a mechanism that enables secure connection of the given connected device 100 to the given cloud, however other mechanisms (such as using an IP address through which the given connected device 100 can connect to the given cloud) are contemplated as well. It is to be further noted that the identification information enabling identification of the given cloud to which the given connected device 100 is to connect can be retrieved from the data repository 320 as detailed herein (as such information is stored on data repository 320 for each connected device 100).

The connection information sent by the cloud switch at block 630 is received by the given connected device 100 (block 420), which utilizes them for establishing a connection with the given cloud, and for registering to one or more publish/subscribe channels of a publish/subscribe service (e.g. an MQTT based publish/subscribe service) provided by the given cloud (block 430). Through the established connection, the given connected device 100 sends, via one of the publish/subscribe channels (of the publish/subscribe service provided by the given cloud) to which the given connected device 100 is registered. at least one message to the given cloud, for storage and/or analysis (block 440).

Each message sent by the given connected device 100 to the given cloud is received by the given cloud where they can be stored and/or, analyzed. In some cases, such messages are also forwarded by the given cloud to the cloud switch 110 (and/or to other entities that subscribe to receive such messages from the given cloud) that receives them (block 640) for various purposes. In addition, the cloud switch 110 can optionally send at least one message to the given connected device 100 (block 650). Such messages can be sent by the cloud switch 110 to the given connected device 100 directly (e.g. according to the Message Queuing Telemetry Transport (MQTT) standard or by Representational State Transfer (REST) messages), or via the connection established at block 430 (utilizing the cloud device identifier identifying the given connected device 100 at the given cloud), or via one of the publish/subscribe channels (of the publish/subscribe service provided by the given cloud) to which the given connected device 100 is registered. The messages sent by the cloud switch 110 to the given connected device 100 can be control messages designed to cause the given connected device to perform various operations (e.g. remote reset, request logs, firmware update, setting one or more parameters, requesting values of one or more parameters, etc.).

The given connected device 100 can be further configured to monitor if the connection to the given cloud was disconnected (block 450). Such monitoring can be performed by continuously or periodically (e.g. every pre-determined time interval, whenever an attempt is made to send a message at block 440, etc.). If a disconnection is identified, the cloud connection process 400 and the connected device connection process 600 can repeat for re-establishing the connection.

One exemplary reason for a disconnection is usage of temporary unique security credentials. In such cases, the unique security credentials generated by the given cloud for the given connected device 100 are valid for a limited period of time, after which they expire and do not enable connection of the given connected device 100 to the given cloud. In such cases, the given connected device 100 is required to obtain new unique security credentials, other than the previously used unique security credentials obtained at block 620, upon expiry of the previously generated unique security credentials that are no longer valid.

Another exemplary reason for a disconnection is when a cloud switch is performed during which the given cloud is instructed to disconnect the given connected device 100 therefrom. In such case, upon repeating the cloud connection process 400 and the connected device connection process 600, the identification information enables identification of a second cloud, other than the given cloud, to which the given connected device 100 is to connect. In addition, the cloud device identifier and the unique security credentials obtained at block 620 are be generated by the second cloud. As a result, the connection established at block 430 in such case, is between the given connected device 100 and the second cloud.

It is to be noted that, with reference to FIGS. 4 and 6, some of the blocks can be integrated into a consolidated block or can be broken down to a few blocks and/or other blocks may be added. Furthermore, in some cases, the blocks can be performed in a different order than described herein (for example, block 650 can be performed before block 640, block 450 can be performed before block 440). It is to be further noted that some of the blocks are optional. It should be also noted that whilst the flow diagram is described also with reference to the system elements that realizes them, this is by no means binding, and the blocks can be performed by elements other than those described herein.

Turning to FIGS. 5 and 7, there are shown flowcharts illustrating one example of sequences of operations carried out for reconfiguring a connected device to connect to another network of interconnected computers, in accordance with the presently disclosed subject matter.

According to some examples of the presently disclosed subject matter, connected device 100 and the cloud switch 110 can be configured to execute a cloud switch process 400 and a connected device cloud switch process 600 respectively, for connecting a given connected device 100 to a cloud other than a cloud to which it is connected, and for registering the given connected device 100 to one or more publish/subscribe channels of a publish/subscribe service (e.g. an MQTT based publish/subscribe service) provided by the other cloud (other than the one to which it is connected). Connected device 100 can execute the cloud switch process 400 utilizing cloud switch module 250. Cloud switch 110 can execute the connected device cloud switch process 600 utilizing the connected device cloud switch module 350.

For this purpose, cloud switch 110 can be configured to check if a switch instruction is received (e.g. from a user such as a manufacturer of a certain group of connected devices 100 comprising the given connected device 100) or if other criteria is met (block 710). The check can be performed continuously or periodically (e.g. every pre-determined time interval and/or whenever an activation request is received at block 610, etc.).

In some cases, the criteria can include one or more of the following (non-limiting):
a. one or more performance measures (e.g. latency/availability/bandwidth/throughput/jitter/error rate, etc.) of a publish/subscribe service (e.g. an MQTT based publish/subscribe service) provided by the cloud to which the given connected device 100 is connected to do not meet a corresponding threshold;
b. one or more performance measures (e.g. latency/availability/bandwidth, etc.) of the cloud to which the given connected device 100 is connected to do not meet a corresponding threshold;
c. one or more security requirements (e.g. various security standard requirements relating to communication, storage, Disaster Recovery (DR), etc.) are not met by the cloud to which the given connected device 100 is connected to;
d. a first cost of the connection of the given connected device to the cloud to which it is connected to is higher than a cost of a connection of the given connected device to another cloud, other than the cloud to which it is connected to (e.g. based on analysis of average usage of the connected device 100 over a given period of time such as a day/week/month/etc.);
e. a current time of day is within a predetermined range (e.g. in cases where the connected device 100 is to be connected to a first cloud during a certain part of the day (e.g. 8:00-20:00) and to a second cloud during another part of the day (e.g. 20:00-8:00), for example due to cost considerations, different usage requirements during the different parts of day, etc.);
f. a current geographical location of the given connected device 100 is within a predetermined geographical area (e.g. upon initial installation thereof or due to a geographical location change so that the given connected device 100 is now within the predetermined geographical area, other than another geographical area in which it was previously located). For example, when the connected device 100 is located in Europe, there may be a requirement that it connects to a cloud whose servers are located in Europe, whereas in other cases it can connect to other clouds that are not located in Europe, that can be cheaper and/or have better performance, etc.; and
g. any other criteria, including criteria based on Service Level Agreements (SLAs).

It is to be noted that the switch instruction includes identification information enabling identification of a newly designated cloud, other than the cloud to which the given connected device 100 is connected to, to which the given connected device 100 is to connect, and information identifying the publish/subscribe channels of a publish/subscribe service (e.g. an MQTT based publish/subscribe service) provided by the newly designated cloud to which the given connected device 100 is to register. In a similar manner, if switching clouds is due to one or more of the criteria being met, the cloud switch 110 can determine, according to the criteria being met, identification information enabling identification of the newly designated cloud.

It is to be noted that in some cases, when switching clouds due to failure of a given cloud, or a publish/subscribe service (e.g. an MQTT based publish/subscribe service) thereof, to meet performance measures thresholds/requirements, the cloud switch identifies the newly designated cloud to which the connected devices switch to, and/or the publish/subscribe service (e.g. an MQTT based publish/subscribe service) provided by the newly designated cloud to which the given connected device 100 is to register, by verifying that the performance of the newly designated cloud and/or the publish/subscribe service (e.g. an MQTT based publish/subscribe service) provided by the newly designated cloud meet the thresholds/requirements. It is to be noted that accordingly, switching clouds can be made in order to perform load balancing between loads of a plurality of clouds/cloud service providers/publish/subscribe services, etc.

If a switch instruction is received, or the other criteria is met, cloud switch 110 can be configured to update the data repository 320 with identification information enabling identification of the newly designated cloud (block 720).

In some cases, the process can end here, so that when the given connected device 100 identifies a disconnection at block 450 a new activation request will be sent thereby to the cloud switch 110, this time leading to connecting the given connected device 100 to the newly designated cloud.

However, in other cases, switching clouds can be performed proactively. In such cases, the cloud switch 110 can be configured to obtain a cloud device identifier and unique security credentials enabling connecting the connected device 100 to the newly designated cloud, and enabling registering the connected device 100 to one or more publish/subscribe channels of a publish/subscribe service (e.g. an MQTT based publish/subscribe service) provided by the newly designated cloud (block 730). For this purpose, the cloud switch 110 can be configured to check if the given connected device 100 has a cloud device identifier previously generated by the newly designated cloud in the past stored on the data repository 320. If so—the cloud switch 110 obtains such cloud device identifier and requests the newly designated cloud to generate and provide the unique security credentials for enabling the given connected device 100 to connect thereto. If no cloud device identifier exists for the given connected device 100—the cloud switch 110 requests the newly designated cloud to generate and provide both the cloud device identifier for identifying the given connected device 100 at the newly designated cloud, and the unique security credentials for enabling the given connected device 100 to connect to the newly designated cloud and to register the connected device 100 to one or more publish/subscribe channels of a publish/subscribe service (e.g. an MQTT based publish/subscribe service) provided by the newly designated cloud.

If a new cloud device identifier is generated for the given connected device 100, the cloud switch 110 stores the new cloud device identifier in the data repository in association with the given connected device 100 and with newly designated cloud (that generated such cloud device identifier) for future use. It is to be noted that in some cases for each connected device 100 that connects to a newly designated cloud, the newly designated cloud generates information that enables at least storing various information received from such connected device 100 in the newly designated cloud. In some cases, for each connected device 100 that connects to a newly designated cloud, the newly designated cloud allocates storage space for storing data originating from such connected device 100.

Once the cloud device identifier and the unique security credentials associated with the given connected device 100 are obtained at block 730, the cloud switch 110 can send, to the given connected device 100, via the communication network, connection information enabling connecting the given connected device 100 to the newly designated cloud, and enabling registering the connected device 100 to one or more publish/subscribe channels of a publish/subscribe service (e.g. an MQTT based publish/subscribe service) provided by the newly designated cloud (block 740). The connection information includes the cloud device identifier and the unique security credentials obtained at block 730 and identification information enabling identification of the newly designated cloud to which the given connected device 100 is to connect. The identification information enabling identification of the newly designated cloud to which the given connected device 100 is to connect can include a Uniform Resource Locator (URL) associated with the newly designated cloud (or more specifically with a specific endpoint, such as a computer, a router, a load balancer, etc., that is part of the newly designated cloud) through which the given connected device 100 can connect to the newly designated cloud using the cloud device identifier and the unique security credentials provided thereto. It is to be noted that a URL using Fully Qualified Domain Name (FQDN) is one example of a mechanism that enables secure connection of the given connected device 100 to the given cloud, however other mechanisms (such as using an IP address through which the given connected device 100 can connect to the given cloud) are contemplated as well.

The connection information sent by the cloud switch at block 740 is received by the given connected device 100 as part of a cloud switch instruction (block 510), where they are utilized for establishing a connection with the newly designated cloud and for registering the given connected device 100 to one or more publish/subscribe channels of a publish/subscribe service (e.g. an MQTT based publish/subscribe service) provided by the newly designated cloud (block 520). In addition to establishing the connection with the newly designated cloud, the given connected device 100 can be configured to disconnect the connection with the cloud to which it was previously connected (block 530).

Through the established connection, the given connected device 100 can send at least one message to the newly designated cloud, for storage and/or analysis (block 540), e.g. via one of the publish/subscribe channels (of the publish/subscribe service provided by the given cloud) to which the given connected device 100 is registered.

Each message sent by the given connected device 100 to the newly designated cloud is received by the newly designated cloud where they can be stored and/or analyzed. In some cases, such messages are also forwarded by the newly designated cloud to the cloud switch 110 that receives them (block 750) for various purposes, or, in cases the cloud switch 110 is also registered to the publish/subscribe channel (of the publish/subscribe service provided by the given cloud) to which the given connected device 100 is registered and through which the message was sent, such messages are automatically received thereby. In addition, the cloud switch 110 can optionally send at least one message to the given connected device 100 (block 760). Such messages can be sent by the cloud switch 110 to the given connected device 100 directly (e.g. according to the Message Queuing Telemetry Transport (MQTT) standard), via the connection established at block 520 (utilizing the cloud device identifier identifying the given connected device 100 at the newly designated cloud), or via one of the publish/subscribe channels (of the publish/subscribe service provided by the given cloud) to which the given connected device 100 is registered. The messages sent by the cloud switch 110 to the given connected device 100 can be control messages designed to cause the given connected device to perform various operations (e.g. remote reset, request logs, firmware update, setting one or more parameters, requesting values of one or more parameters, etc.)

It is to be noted that in some cases, the cloud switch 110, can be configured to initiate migration of the data relating to the given connected device 100 stored on the cloud to which the given connected device 100 was connected before disconnecting the connection at block 530, to the newly designated cloud. In that case, the cloud switch 110 can utilize the security credentials of the given connected device 100 to access the given connected device's historical data in the cloud to which it was connected, read it, and write it to the newly designated cloud.

It is to be further noted that the given connected device 100 can be configured to monitor disconnections and perform any action derived from such disconnections being identified as detailed herein with reference to FIG. 4, also after establishing the connection to the newly designated cloud, thereby maintaining a connection between the given connected device 100 and the newly designated cloud.

It is to be still further noted that a switch command can be received by the cloud switch 110 for a group of two or more connected devices 100 simultaneously. For example, a given manufacturer of a group of connected devices 100 can request all such connected devices 100, or a sub-group thereof, to switch clouds. As another example, the sub-group can be identified by the location of the devices, so that all devices within a certain geographical area are requested to switch clouds.

It is to be yet further noted that in some cases, instead of switching clouds, the connected devices 100 can be capable of simply connecting to an additional cloud additional to the cloud/s to which it is currently connected. As indicated herein, a given connected device 100 can be simultaneously connected to more than one cloud, and registered to one or more channels of two (or more) publish/subscribe services, one provided by cloud A 120 and one provided by cloud B 130. In some cases, the given connected device 100 can be configured to publish any message generated thereby on the channels of both publish/subscribe services (provided by cloud A 120 and by cloud B 130), or it can have a mechanism for deciding on which publish/subscribe service to publish each message generated thereby (on the publish/subscribe service provided by cloud A 120 or on the publish/subscribe service provided by cloud B 130). This multiple-connection mechanism can enable, for example, load balancing between a plurality of clouds/publish/subscribe services.

It is to be further noted that, with reference to FIGS. 5 and 7, some of the blocks can be integrated into a consolidated block or can be broken down to a few blocks and/or other blocks may be added. Furthermore, in some cases, the blocks can be performed in a different order than described herein (for example, block 530 can be performed before block 520, block 750 can be performed before block 740). It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method for switching between publish/subscribe services, the method comprising:
monitoring one or more performance measures of a first publish/subscribe service provided by a first secure network of interconnected computers, the first publish/subscribe service used by a plurality of connected devices connected to the first secure network of interconnected computers via respective first connections;
upon one or more of the performance measures of the first publish/subscribe service failing to meet respective performance requirements, identifying a second publish/subscribe service provided by a second secure network of interconnected computers, wherein the performance measures of the second publish/subscribe service meet the respective performance requirements; and
sending one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.

2. The method of claim 1 wherein the performance measures includes at least one of: bandwidth, latency, throughput, jitter or error rate.

3. The method of claim 1 wherein the switch instruction is received by the connected devices of the sub-group via the first connection.

4. The method of claim 1 wherein the monitoring, identifying and sending is performed by a cloud switch server that is not part of the first secure network of interconnected computers and of the second secure network of interconnected computers.

5. The method of claim 1, further comprising disconnecting the first connections of the connected devices of the sub-group after the second connections are established.

6. The method of claim 1 wherein past data associated with the connected device and stored on the first secure network of interconnected computers is migrated to the second secure network of interconnected computers after the second connection is established.

7. The method of claim 1 wherein at least one of (a) the first publish/subscribe service, or (b) the second publish/subscribe service, is an Message Queuing Telemetry Transport (MQTT) based publish/subscribe service.

8. A system for switching between publish/subscribe services, the system comprising a processing resource configured to:
monitor one or more performance measures of a first publish/subscribe service provided by a first secure network of interconnected computers, the first publish/subscribe service used by a plurality of connected devices connected to the first secure network of interconnected computers via respective first connections;
upon one or more of the performance measures of the first publish/subscribe service failing to meet respective performance requirements, identify a second publish/subscribe service provided by a second secure network of interconnected computers, wherein the performance measures of the second publish/subscribe service meet the respective performance requirements; and
send one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.

9. The system of claim 8, wherein the performance measures includes at least one of: bandwidth, latency, throughput, jitter or error rate.

10. The system of claim 8, wherein the switch instruction is received by the connected devices of the sub-group via the first connection.

11. The system of claim 8, wherein the processing resource is part of a cloud switch server that is not part of the first secure network of interconnected computers and of the second secure network of interconnected computers.

12. The system of claim 8, wherein past data associated with the connected device and stored on the first secure network of interconnected computers is migrated to the second secure network of interconnected computers after the second connection is established.

13. The system of claim 8 wherein at least one of (a) the first publish/subscribe service, or (b) the second publish/subscribe service, is an Message Queuing Telemetry Transport (MQTT) based publish/subscribe service.

14. A non-transitory computer readable storage medium having computer readable program code embodied therewith, the computer readable program code, executable by at least one processing resource of a computer to perform a method comprising:
monitoring one or more performance measures of a first publish/subscribe service provided by a first secure network of interconnected computers, the first publish-subscribe service used by a plurality of connected devices connected to the first secure network of interconnected computers via respective first connections;
upon one or more of the performance measures of the first publish/subscribe service failing to meet respective performance requirements, identifying a second publish/subscribe service provided by a second secure network of interconnected computers, wherein the performance measures of the second publish/subscribe service meet the respective performance requirements; and
sending one or more switch instructions for switching the connection of at least a sub-group of the connected devices from the respective first connections to the first secure network of interconnected computers to respective second connections to the second secure network of interconnected computers, the switch instruction including switch information comprising (a) identification information enabling identification of the second secure network of interconnected computers, (b) a respective cloud device identifier generated by the second secure network of interconnected computers and enabling the second secure network of interconnected computers to identify the respective connected device of the sub-group; and (c) unique security credentials enabling only the respective connected device of the sub-group to connect to the second secure network of interconnected computers and to register to the second publish/subscribe service.
